(19) United States
(12) Patent Application Publication
(10) Pub. No.: US 2008/0220136 A1
(43) Pub. Date: Sep. 11, 2008

(54) Method for Producing Dried Foods to be Eaten After Cooked or Reconstituted with Hot Water, and Dried Noodles

(75) Inventors: Keiichi Ookubo, Yuuki-gun Ibaraki (JP); Nobuaki Matsuzawa, Yuuki-gun Ibaraki (JP); Akira Yoshio, Yuuki-gun Ibaraki (JP)

Correspondence Address: ROBERTS MLOTKOWSKI SAFRAN & COLE, P.C., P. O. BOX 10064, MCLEAN, VA, 22102-8064, US

(73) Assignee: YAMADAI CORPORATION, Yachiyo-machi, Yuuki-gun Ibaraki (JP)

(21) Appl. No.: 10/582,664

(22) PCT Filed: Dec. 22, 2004
(86) PCT No.: PCT/JP2004/019191

§ 371 Date: Jun. 13, 2006

(30) Foreign Application Priority Data
Dec. 25, 2003 (JP) 2003-428904

(51) Int. Cl. A23L 1/16

(52) U.S. Cl. 426/451; 426/557

(57) ABSTRACT

To provide a method for manufacturing, etc., dried foods that can be cooked or reconstituted in hot water in a short time and have a good texture and a good unraveling property. [Solution Means] A dried food is manufactured by subjecting a to-be-processed object, obtained by shaping a prepared object of a raw material containing starchy matter to a predetermined shape, to at least: (1) a first step P₁ of performing a boiling treatment; (2) a second step P₂ of putting the boiled to-be-processed object in contact with an aqueous solution after the abovementioned first step P₁; and (3) a third step P₃ of subjecting the to-be-processed object, subjected to the abovementioned second step P₂, to a wind drying treatment at conditions of a temperature of 45 to 100° C. and a humidity of 5 to less than 55%.

### TECHNICAL FIELD

The present invention relates to an art of manufacturing dried food that is eaten after being cooked or reconstituted in hot water.

### BACKGROUND ART

Various dried foods are known that are designed to be restored to a texture and a flavor suited for eating upon being cooked or reconstituted in hot water. Non-fried instant noodles, fried instant noodles, dry noodles, pasta, macaroni, bean-starch vermicelli, and rice noodles, can be cited as examples.

Such dried foods are generally obtained by processing a dough, etc., prepared from a raw material containing starchy matter, to a predetermined shape, changing the Theological properties of the abovementioned starchy matter by swelling, softening, etc., by heating while supplying water (adding water), and then applying a drying treatment.

In regard to quality, such a dried food is required to (1) approximate as much as possible the texture and the flavor of the food as cooked from the raw state, (2) be not powdery, (3) have luster, (4) enable hot water cooking or hot water reconstitution in a short time (instant preparation property), and (5) in the case of instant noodles, dry noodles, and other noodles, be good in unraveling property.

To cite methods of manufacturing non-fried instant noodles as examples of major conventional arts, firstly, the so-called “hot wind drying method,” in which hot wind drying is performed after a steaming treatment, can be cited. Non-fried noodles obtained by this method are powdery because the noodle strings cannot be pregelatinized adequately and differ greatly in texture, noodle quality, etc., from cooked raw noodles.

There is also known the so-called “freeze dry method” of first preparing boiled noodles and then subjecting the noodles to water rinsing and rapid freeze drying. Though this method enables the texture to approach that of cooked raw noodles to some degree, this method has such issues as the flavor being readily lost when the water content is removed in the process of freeze drying, the drying time being long, the manufacturing equipment being expensive, and the manufacturing cost being high.

Patent Document 1 discloses a method of boiling raw noodle strings, water-rinsing and then water-draining the boiled noodles subjected to the boiling treatment, freezing the noodles in this state, and then subjecting the completely frozen noodles to a process of semi-drying or drying while thawing the noodles under ice temperature. With this method, the flavor is lost readily and a long time is required for drying.

The Applicant of the present Application/Patent has proposed a method for manufacturing non-fried noodles, in which, after boiling raw noodles or dry noodles, the boiled noodles are immersed in water or a modifying solution at 5 to 60° C. and then dried by cool wind under conditions of a temperature of 0 to 35° C. and a humidity of 10 to 60% (see Patent Document 2) .

Furthermore, the present Patent Applicant has proposed a method for manufacturing non-fried noodles, in which, after boiling raw noodles or dry noodles, the boiled noodles are left to stand, then rinsed with water or a solution containing a noodle quality improver, and then dried by cool wind under conditions of a temperature of 0 to 40° C. and a humidity of 10 to 60% (see Patent Document 3).

Though the non-fried noodles obtained by the above manufacturing methods proposed by the Applicant of the present Application/Patent approximate cooked raw noodles, have a smooth texture, and realize hot water reconstitution in a short time, there was still room for improvement in terms of reproducing a texture approximating that of cooked raw noodles, shortening of the hot water reconstituting time, etc.
Patent Document 1: Japanese Published Unexamined Patent Application No. H1-153055
Patent Document 2: Japanese Patent Publication No. 3394937
Patent Document 3: Japanese Patent Publication No. 3440231

### DISCLOSURE OF THE INVENTION

### Object to be Achieved by the Invention

A principal technical theme of the present invention is thus to provide a method for manufacturing dried foods that can be cooked in hot water or reconstituted in hot water in a short time and are good in texture and unraveling property, the dried food manufacturing method being high in productivity and enabling reduction of manufacturing cost, and a principal object of the present invention is to achieve this theme.

### Means for Achieving the Object

The present invention firstly provides a method for manufacturing dried foods that are eaten after being cooked in hot water or reconstituted in hot water. This manufacturing method is especially suited as an art for manufacturing dried foods that are designed in quality so as to be restored to a state suited for eating in terms of flavor and texture by simmering, cooking, boiling, steaming or other form of hot water cooking or by being put in contact with hot water.

With the manufacturing method according to the present invention, first, a step of obtaining a prepared object from a raw material containing starchy matter and then obtaining a to-be-processed object by processing the prepared object to a predetermined shape suited for an intended final product, is performed, and then at least the following steps of (1) to (3) are performed successively on the to-be-processed object.

(1) A first step of subjecting the abovementioned to-be-processed object to a boiling treatment.

This “first step” is a step in which the to-be-processed object is boiled in hot water for a predetermined time. In this step, water is supplied adequately to the to-be-processed object at the same time as applying heat to the to-be-processed object.

Though starch grains in the to-be-processed object have portions in which glucose molecule chains of amylose and amylopectin are aligned in an orderly manner and form micelles that are dense enough to prevent the entry of water, when the “boiling treatment” is performed, the motions of starch molecules become active so that water eventually enters into the abovementioned micelle portions. The starch molecule chains are thereby made to undergo a structural change to a disordered alignment and swell. Also as the crystallinity of the starch is lost, the starch changes in rheological properties gradually and becomes soft. This boiling treatment step is an important step that substantially determines the texture at the point of eating.

In the present invention, the to-be-processed object is preferably subject to a “heating treatment” in advance in a preliminary stage before the first step. For example, by performing a heating treatment, such as a “steaming treatment,” in the preliminary stage before the first step is entered, starch grains that exist on surface portions of the to-be-processed object are retained in a swollen state without reaching a disrupted state. At the same time, the textural structure of the to-be-processed object surface is strengthened and becomes as if a coating is formed. Dissolution by boiling, etc., can thereby be prevented in the subsequent boiling treatment step and the surface portions of to-be-processed object can be prevented effectively from sticking together.

As a result, an extremely favorable effect of improving the airiness of (passage of air through) the to-be-processed object in a subsequent wind drying step is obtained. In a case where the to-be-processed object is a noodle, etc., the “unraveling property” of the noodle at the point of eating can also be improved by the abovementioned effect.

(2) A second step of putting the to-be-processed object, subjected to the first step, in contact with an aqueous solution.

In this step, the to-be-processed object that was subject to the boiling treatment in the first step is transferred from the hot water into an aqueous solution of a lower temperature and put in contact with the aqueous solution for a predetermined time.

This second step is characterized in that a large change in thinking is made to intentionally cause the occurrence, within an appropriate range, of a “phenomenon similar to so-called over-softening due to boiling,” which is generally known, as practically common-sense knowledge among those skilled in the art, to be an unfavorable phenomenon in the manufacturing of dried foods. This second step is carried out for the following four purposes.

A first purpose of the second step is to eliminate stickiness due to starchy matter that is eluted to the surface in the process of the boiling treatment. The sticking of portions of the to-be-processed object to each other is thereby made less likely to occur. When the mutual sticking of surface portions of the to-be-processed object is prevented, subsequent steps are entered with the to-be-processed object being maintained in a state in which internal gaps and voids are secured. Thus in particular, air can be passed readily through the to-be-processed object in the subsequent wind drying step (third step). As a result, the drying efficiency is improved significantly and wind drying within a short time is enabled.

A second purpose of the above-described second step is to perform swelling (volume increase, weight increase) of the to-be-processed object by making water permeate into a central portion of the to-be-processed object and to coarsen the textural structure by interposition of water.

A third purpose of the above-described second step is to subject the to-be-processed object, which, by having gone through the first step (boiling treatment), was made higher in water content at the surface side than at central portions, to a lessening of the difference in water amount (water content difference) between the surface and the central portion of the to-be-processed object, that is, to an adjustment such that the to-be-processed object is made as small in water content gradient as possible. By this water content gradient adjustment, drying progresses more quickly at the surface of the to-be-processed object than at the central portion in the subsequent wind drying step (third step).

A fourth purpose of the above-described second step is to cool the to-be-processed object, subjected to the boiling treatment in the first step, to promote realignment of starch molecule chains at the to-be-processed object surface before entering subsequent steps.

(3) A third step of subjecting the to-be-processed object, subjected to the above-described second step, to a wind drying treatment at conditions of a temperature of 45 to 100° C. and a humidity of 5 to less than 55%.

This third step is characterized in that rapid aid drying is performed in a short time at a medium to high temperature range and a low humidity condition. Priorly, the Applicant of the present Application/Patent proposed, in the abovementioned Patent Document 2, a method of cool wind drying at conditions of a temperature of 0 to 35° C. and a humidity of 10 to 60%, or proposed, in Patent Document 3, a method of cool wind drying at conditions of a temperature of 0 to 40° C. and a humidity of 10 to 60%. However, in the process of continued research, the present Applicant and others greatly changed the idea of cool wind drying of the prior invention and conducted experiments of drying the to-be-processed object, subjected to the above-described first step and second step, at a medium to high temperature range of no less than 45° C. and a low humidity.

As a result, it was found that foods having better texture and enabling hot water reconstitution to be performed in a shorter time can be provided and that improvement of productivity and reduction of manufacturing cost can be achieved reliably. It was also found that, because by setting the temperature condition in the medium to high temperature range, the effect of reliably restraining the proliferation of coliform bacteria and general bacteria is provided, the present manufacturing method can become a more generally practiced art.

A first purpose of this third step is to expose the to-be-processed object, which was made to absorb water in the first step and second step, to a wind of low humidity to rapidly remove water from the to-be-processed object and thereby obtain a dried food or a semi-dried food of low water content that is also suitable for long-term storage.

A second purpose of the above-described third step is to intentionally carry out deformation to increase the surface area of the dried food that is the final product and to intentionally form cracks and voids in the food. This is based on the finding, obtained through diligent research by the present Applicant and others, that in cooking or reconstituting a dried food in hot water, the magnitude of the surface area of the food that comes in contact with the hot water greatly influences the hot water reconstituting time or cooking time.

When wind drying under the abovementioned temperature and humidity conditions is performed for a predetermined time on the to-be-processed object, which enters this third step upon having been supplied with water, adjusted to be small in the water content gradient across the surface and the central portion, and treated so as to be in a non-sticking state in the above-described first step (boiling treatment) and the second step (aqueous solution contact), a difference in the progress of drying arises between the surface and the central portion of the to-be-processed object.

Because the surface, at which drying progresses faster, solidifies rapidly ahead of the central portion, and the interior of the to-be-processed object is put in a depressurized state as water is accompanyingly removed from the central portion that is slow in the progress of drying and is yet in a soft state, a thinned portion is formed due to compression and deformation by atmospheric pressure.

Especially in a case where the to-be-processed object has a cross-sectional shape in the width direction of rectangular or elliptical shape, the surface portions in the longitudinal direction of the cross section deform concavely toward the central portion to form a thinned portion. In the process in which such deformations occur, contraction and distortion occur in the internal textural structure of the to-be-processed object so that cracks and voids are formed. Voids are especially formed numerously at the central portion at which contraction and distortion are concentrated.

By the above, (1) the drying efficiency is improved because water at the central portion is made to evaporate readily from the thinned portion, (2) the hot water contacting efficiency is improved due to significant increase of the surface area that comes in contact with hot water by the deformation (thinning), (3) the permeation of hot water can be quickened by the cracks and voids, (4) heat conduction and permeation of hot water into the central portion is promoted due to the presence of thinned portion, and (5) a smooth texture, such as that obtained when raw noodles are cooked, can be obtained because cracks and voids are not present on the surface. By the actions of (1) to (5), improvement of productivity and reduction of manufacturing cost can be achieved and a food that can be hot water reconstituted or hot water cooked in a short time and is good in texture (a food without portions that are inadequately hot water cooked or hot water reconstituted) can be obtained.

Here, to maintain a high wind drying efficiency in the third step, it is important to maintain a low humidity environment in the dryer or drying chamber, etc. Wind drying is thus preferably performed by a non-circulating method and/or under a dehumidified environment. Such wind drying by a non-circulating method and wind drying under a dehumidified environment may be performed independently of each other or in combination. It is especially preferable to employ drying by a non-circulating method to achieve rapid drying reliably at an initial stage of drying.

Because by employing such a wind drying means, humid air will not be used repeatedly and a low humidity can be maintained reliably, the proliferation of microorganisms in the dryer or drying chamber can be restrained.

With the present invention, the to-be-processed object is preferably subject to “standing” for a predetermined time in a step between the above-described second step and the above-described third step. For example, a step of letting the to-be-processed object stand under an indoor environment can be selected. Letting stand in a refrigerating temperature range is more preferable in this case since the proliferation of microorganisms can then be restrained. Also in the standing step, a step of immersing the to-be-processed object in an aqueous solution may be employed.

In the case where the standing step of letting stand under an indoor environment is employed, by performing this step at a stage subsequent the second step (aqueous solution contacting step), the water on the surface of the to-be-processed object is eliminated appropriately and aging of the surface is thus made to progress appropriately. As a result, mutual sticking of surface portions can be prevented effectively. Also in the case where either letting stand under an indoor environment or immersion in an aqueous solution is employed, the water absorbed in the above-described second step can be made to spread gradually across the entirety of the to-be-processed object, and the adjustment of the water content gradient between the surface and the central portion of the to-be-processed object can thus be performed effectively in continuation to the second step.

An effect equivalent to the water content gradient adjustment effect of the standing step can also be achieved by carrying out the preceding second step (aqueous solution step) over a longer time.

With the present invention, following the above-described standing step, the wind drying step (third step) may be entered after performing “water rinsing” of the to-be-processed object. A main purpose of this water rinsing step is to make a flow of water act on the to-be-processed object to “unravel” the to-be-processed object. An unraveling property improver or other additive may be added to achieve this purpose more readily.

Because by this “unraveling effect,” gaps are formed more reliably in the to-be-processed object, the airiness of (passage of air through) the to-be-processed object in the subsequent wind drying process (third step) is improved further and the wind drying efficiency can thus be improved further. Also this unraveling effect by “water rinsing” connects directly to the improvement of the unraveling property of the food after being reconstituted or cooked in hot water.

The above-described manufacturing method according to the present invention is favorable for manufacturing, for example, non-fried instant noodles, fried instant noodles, dry noodles, spaghetti, bean-starch vermicelli, and rice noodles. Besides noodles, the invention can be used to manufacture pastas besides spaghetti as well as dried foods, such as macaroni. In a case of use in the manufacture of non-fried instant noodles, noodles having a texture extremely close to that of cooked raw noodles, a smooth surface, and a good unraveling quality can be provided.

The present invention also provides dried noodles having the following characteristics (1) to (3) in terms of textural structure or form: (1) voids are present in the interiors of noodle strings after drying; (2) in the noodle strings after drying, cracks are present dispersedly in a range from a central portion to the surface; and (3) a thinned portion is found to be present when a cross-sectional shape in the width direction of a noodle string is observed.

The inventors of the present Application have newly found as a result of long years of research that with dried noodles having all of the characteristics described above, the time required for hot water cooking or hot water reconstitution is short and the texture is extremely close to that of cooked raw noodles.

As reasons for this, it is firstly presumed that, because with the dried noodles according to the present invention, a thinned portion is formed, the surface area of the entirety of each noodle string is made large and the efficiency of contact of the noodle string with hot water is improved significantly. It is also presumed that due to the presence of the above mentioned thinned portion, transfer of heat and permeation of hot water into the central portion are promoted and the restoration of texture is thereby quickened. Secondly, it can presumed that hot water permeates towards the central portion by the capillary phenomenon, etc., via the numerous cracks formed in the range from the central portion to the surface and thereby softens the entirety of each noodle string uniformly.

With the dried noodles having the textural structure or form characteristics of (1) to (3) described above, after hot water cooking or hot water reconstituting, the abovementioned thinned portions swell and the outer shapes thereof are restored to the outer shapes prior to the drying treatment so that a smooth surface is formed and a core is not left in the central portion of each noodle string.

Technical terms used in the present invention shall now be described.

Firstly, “dried foods,” which are the objects manufactured by the method according to the present invention, refer to foods that are artificially lowered in water content, and include foods of low water content (for example, approximately 10%) that can withstand long-term storage as well as semi-dried foods of comparatively high water content.

The “raw material containing starchy matter” used in the present invention refers widely to starchy matter contained in seeds, roots, stems, tubers, and tuberous roots of plants, and include raw materials derived from wheat, buckwheat, rice, corn, mung bean, potato, sweat potato, tapioca as well as raw materials obtained from barley, rye, oat, adlay, kudzu, etc., and is not to be interpreted narrowly.

“Prepared object” refers to an object obtained by conditioning and processing the above-described raw material and refers, for example to an object (such as dough) that is obtained by adding water and additives (such as table salt, brine), suited for the purpose, to the above-described raw material and subjecting the raw material to a treatment, such as mixing, gestating, kneading, rolling, etc.

The “to-be-processed object” to be treated in the first step onward of the manufacturing method according to the present invention refers to an object with a form such as string-like, rod-like, ribbon-like, etc., as well as to an object with which objects of such form are aligned or aggregated with voids or gaps inbetween, and in the case of noodles, refers to an aggregate of noodle strings.

The “aqueous solution” used in the second step of the manufacturing method refers widely to water, modifying solutions, and other liquid-phase objects. “Modifying solution” refers to aqueous solutions containing pH adjusters, aqueous solutions containing unraveling property improvers, aqueous alcohol solutions, aqueous solutions containing taste additives, and other solutions that contain additives.

Wind drying by the “non-circulating method” that relates to the third step of the manufacturing method refers to a wind drying method in which air that was used once for drying and made high in humidity is not reused. Wind drying “under a dehumidified environment” refers to a wind drying method in which a dehumidifier, etc., is installed inside a drying chamber or a dryer and air is blown while performing forced dehumidification.

### EFFECTS OF THE INVENTION

With the manufacturing method according to the present invention, because measures are taken to adjust the water content gradient and prevent surface sticking adequately in stages before wind drying and wind drying is performed under conditions of favorable temperature and humidity, the surface area of a dried food can be increased and a large number of cracks and voids can be formed. Because the surface area of the food that contacts hot water is thus increased significantly and the permeation of hot water can be quickened, a dried food, which can be reconstituted or cooked in hot water in a short time and has a good texture and a good unraveling property, can be manufactured. Also due to being premised on drying in a short time, the manufacturing method according to the present invention is high in productivity and enables the reduction of manufacturing cost.

The dried noodles by the present invention can shorten the time required for hot water cooking or hot water reconstitution and can provide a texture extremely close to cooked raw noodles. These effects are especially significant in the case of noodles of large diameter and thick noodles.

### BEST MODES FOR CARRYING OUT THE INVENTION

A preferred embodiment of the dried food manufacturing method according to the present invention shall now be described based on FIG. 1, which is a process flow diagram of this method. The dried food manufacturing method according to the present invention is not narrowly restricted to the embodiment and examples described below.

<Prepared Object Forming Step A>

First in the present manufacturing method, a prepared object forming step A is performed on wheat flour or other raw material containing starchy matter.

To cite a few examples, in the case of “Chinese noodles,” predetermined amounts of table salt, brine powder, and water are added to semi-strong wheat flour, and mixing and kneading are performed to form a dough. In the case of “udon,” predetermined amounts of table salt and water are added to medium strength wheat flour, and mixing and kneading are performed to form a dough. In the case of “soba,” predetermined amounts of wheat flour, table salt and water are added to buckwheat flour, and mixing and kneading are performed to form a dough.

In the process of this prepared object forming step A, the proteins (gliadin, glutenin) contained in the wheat flour, etc., change to gluten, which is sticky. This gluten forms networks and gives rise to “chewiness,” which is an important component of texture.

<Shaping Step B>

A shaping step B is then performed following the prepared object forming step A. In other words, the dough, etc., that is the prepared object is processed to a string, rod, ribbon, or other shape to obtain a to-be-processed object.

For example, after forming the prepared object to a predetermined thickness by rolling to a flat form, slicing, cutting out, extrusion, or drawing, etc., is performed to be processed to a desired shape. With the present invention, the method of shaping itself is not restricted narrowly.

An object, with which the shaped objects that are thus obtained are aligned, aggregated, etc., with voids or gaps in between, is used as the to-be-processed object in the subsequent steps. In the case of manufacturing dried noodles, the to-be-processed object is an aggregate of noodle strings that is also generally referred to as a “noodle lump.”

<Heating Treatment Step C>

A heating treatment step C is then performed on the abovementioned to-be-processed object. The heating treatment step C is not an essential step in the present invention and is carried out according to purpose or need. The heating treatment step C is preferably carried out especially in the case of using noodles as the to-be-processed object to manufacture non-fried instant noodles or other dried noodles.

Examples of methods of the heating treatment step C include steaming treatment, microwave treatment, far infrared ray treatment, hot air or warm air treatment. Treatments combining such treatments with a water supplying means can also be cited as examples. The type of heating means employed is selected as suited according to the purpose.

By performing the heating treatment step C at a stage preceding a subsequent first step (boiling treatment step) P₁, the starch grains present on the surface of the to-be-processed object are retained in the swollen state and do not reach the disrupted state in the next step. At the same time, the textural structure of the to-be-processed object surface is strengthened and becomes as if a coating is formed.

Dissolution due to boiling, etc., in the subsequent first step P₁ can thereby be prevented effectively and the mutual sticking of surface portions of the to-be-processed object can be prevented effectively.

The airiness of (passage of air through) the to-be-processed object in a subsequent third step (wind drying step) P₃ is thus improved. In the case where the noodles, etc., are used as the to-be-processed object, the “unraveling property” of the noodles at the point of eating is improved extremely.

For example, in the case of manufacturing non-fried instant noodles or other noodles, by performing the steaming treatment in the heating treatment step C, the effects of preventing dissolution due to boiling, improving the unraveling property, etc., can be obtained reliably.

<First Step (Boiling Treatment Step) P₁>

In this first step P₁, the to-be-processed object that was subject to the processes of the preceding stages is boiled in hot water for a predetermined time. In this first step P₁, water is supplied adequately and, at the same time, heat is applied to the to-be-processed object.

This boiling treatment is performed upon setting a treating time suited for the to-be-processed object to be treated in a boiling water bath. If the boiling time is inadequate, a hard texture (a texture that is sensed as if there is a core) remains in the final product. On the other hand, if the boiling time is too long, the starch grains on the surface become disrupted completely, the softness becomes excessive, and thus in the case of noodles, the unraveling property degrades as well.

In the case of steamed Chinese noodles of a width obtained using a No. 16 or a No. 20 slitter, when the boiling treatment is performed in boiling water for approximately 2 to 4 minutes and especially preferably approximately 3 to 4 minutes, the taste and unraveling property of the dried food (dried noodles) that is the final product become good, and the color tone and other states of the noodle strings also become good.

The duration of the boiling treatment can thus be determined as suited in consideration of the diameter (width), thickness, etc., of the to-be-processed object in addition to whether or not the heating treatment step C was performed in a preceding stage.

<Second Step (Aqueous Solution Contacting Step P₂>

In this second step P₂, the to-be-processed object that was subject to the boiling treatment is transferred from the hot water to an aqueous solution of lower temperature and put in contact with the aqueous solution for a predetermined time.

If necessary in the process of this step P₂, the to-be-processed object that was subject to first step P₁ may be water rinsed by being put in contact with a flowing aqueous solution or may be immersed in the aqueous solution after this water rinsing.

By this method, a water rinsing effect is applied to the above-described to-be-processed object. This is favorable in the case where the final product is noodles, etc., because the unraveling property, etc., of the noodle strings can thereby be improved further.

As the “aqueous solution” used in this second step P₂, water or a modifying solution may be employed. Examples of a “modifying solution” include aqueous solutions containing pH adjusters, aqueous solutions containing unraveling property improvers, aqueous alcohol solutions, aqueous solutions containing taste additives, etc.

As the temperature condition of the aqueous solution, 5 to 55° C. is suitable, and normally, it suffices for the temperature to be room temperature (approximately 15 to 25° C.). Though the to-be-processed object increases in weight by absorbing water in a short time when the temperature exceeds 55° C. and especially when an aqueous solution of a high temperature range of no less than 70° C. is employed, such a temperature condition is not favorable because the surface of the to-be-processed object roughens and becomes sticky.

The favorable duration of contact with the aqueous solution is determined according to the type and physical characteristics of the to-be-processed object and upon adequate consideration of the correlation with the temperature of the aqueous solution.

In this second step P₂, the to-be-processed object is put in contact with the aqueous solution to cause the “phenomenon similar to so-called over-softening due to boiling” to occur within a suitable range. Also by contact with the aqueous solution of low temperature, realignment of starch molecule chains on the surface of the to-be-processed product is promoted, the stickiness due to starchy matter that is eluted to the surface is eliminated, and the sticking of portions of the to-be-processed object to each other is prevented. When mutual sticking of surface portions of the to-be-processed object is prevented, subsequent steps can be performed with the to-be-processed object being maintained in the state in which gaps and voids are secured.

Thus in particular, air can readily be passed uniformly through the to-be-processed object in the subsequent third step (wind drying step) P₃. As a result, the drying efficiency is improved significantly and wind drying within a short time is enabled.

Also in this second step P₂, water is made to permeate into the central portion of the to-be-processed object to achieve volume increase and weight increase and coarsen the textural structure by interposition of water.

Furthermore, by adjusting the water content gradient across the surface and the central portion of the to-be-processed object to become small, the surface and the central portion of the to-be-processed object are made to differ in the progress of drying in the subsequent wind drying step (third step) P₃.

<Standing Step D>

Preferably, measures are taken to subject the to-be-processed object, which was subject to second step P₂, to “standing” for a predetermined time (see FIG. 1).

As this standing step D, a method, for example, of letting the to-be-processed object stand under an environment of −5 to 40° C. or, more favorably, under a surrounding temperature of a refrigerating temperature range to an indoor environment temperature range, may be employed.

The duration of standing under an indoor environment differs according to the type and the shape of the to-be-processed object, the condition settings of the preceding steps, and the standing temperature condition, and for example in the case of Chinese noodles, the standing time may be 10 hours or 15 hours. However in consideration of quality, productivity, etc., approximately 1 to 6 hours is favorable.

If problems of dulling of the color tone, etc., are disregarded, the standing may be carried out for approximately 24 hours. When the standing time is less than 1 hour, hardness may be felt in terms of texture and the unraveling property may be poor.

If the standing time is inadequate, the texture may become hard partially and the unraveling property may be poor. On the other hand if the standing time is excessive, the noodles may lack a chewy texture, change in color tone, etc.

When standing under an indoor environment is performed at a stage subsequent the second step (aqueous solution contacting step) P₂, the water on the surface of the to-be-processed object is removed appropriately and aging of the surface can be made to progress appropriately as well. Mutual sticking of surface portions of the to-be-processed object can thus be prevented more effectively.

Also for this standing step D, a method of immersing the to-be-processed object in an aqueous solution may be employed. Especially in a case where the to-be-processed object is udon or Chinese noodles of thick diameter, letting the to-be-processed object stand in a state of being immersed in an aqueous solution is preferred over the above-described standing method of leaving the to-be-processed object still under an indoor environment.

Carrying out the standing step by immersion in an aqueous solution provides the merit that the water content gradient can be adjusted efficiently in a short time even in the case of udon or Chinese noodles of thick diameter.

By performing such a standing step D, the water absorbed in the above-described second step P₂ can be made to spread across the entirety of the to-be-processed object. As a result, the water content gradient between the surface and the central portion of the to-be-processed object can be adjusted as much as possible in continuation to the above-described second step P₂.

This standing step D thus serves a role of being a complementary step to second step P₂ that has the significance of being a water content gradient adjusting step as well.

<Water Rinsing Step E>

In continuation to the above-described standing step D, a water rinsing step E may be carried out on the to-be-processed object, for which the water content gradient adjustment has been completed, before entering the third step (wind drying step) P₃ (see FIG. 1).

This water rinsing step E may be carried out by loading the to-be-processed object into a flowing aqueous solution, etc. This water rinsing step E is preferably performed, especially in the case where the to-be-processed object is an aggregate of noodle strings.

Because the main purpose of this water rinsing step E is to make a flow of water act on the to-be-processed object to “unravel” the to-be-processed object, an unraveling improver or other additive may be used.

This “unraveling effect” improves the airiness of the to-be-processed object in the subsequent third step (wind drying step) P₃ to further improve the wind drying efficiency and also helps to improve the unraveling property in the process of eating after hot water reconstitution or hot water cooking. This water rinsing step E should thus be employed proactively, especially in the case where the to-be-processed object is noodles.

<Water Draining Step F>

If the third step (wind drying step) P₃ is to be entered upon performing the second step (boiling treatment step) P₂, or if the third step (wind drying step) P₃ is to be entered upon carrying out standing under an indoor environment (standing step D) after performing second step P₂ and then further performing the water rinsing step E thereafter, or if the third step (wind drying step) P₃ is to be entered upon performing standing step D by immersion in an aqueous solution and then furthermore performing the water rinsing step E thereafter, a water draining step F is performed before the subsequent third step (wind drying step) P₃.

In this water draining step F, a method, in which the to-be-processed object that was subject to the process of the previous stage is raised from an aqueous solution tank with the object being contained in a case of a net-like or basket-like form to let the water drop naturally, may be employed. A method of appropriately moving the abovementioned case up and down or a method of forcibly removing the water by use of a centrifuge, etc., may also be employed.

Because by this water rinsing step E, water that is present in the gaps of the to-be-processed object and excess water attached to the surface of the to-be-processed object can be removed, the wind drying efficiency in the subsequent third step P₃ can be improved.

<Third Step (Wind Drying Step) P₃>

In this third step P₃, the to-be-processed object that was subject to the above-described second step P₂, or the to-be-processed object that was subject successively to the standing step D, water rinsing step E, etc., in continuation to second step P₂, is wind dried under conditions of a temperature of 45 to 100° C. and a humidity of 5 to less than 55%.

In this third step P₃, the to-be-processed object, which was successively subject to the suitably selected necessary steps, such as first step P₁→second step P₂, or heating treatment step C→first step P₁→second step P₂→standing step D→water rinsing step E→water draining step F, etc., and has thereby been made to absorb water adequately and adjusted to be as small in water content gradient as possible, is put in contact with air of low humidity under a medium to high temperature condition to rapidly remove water from the to-be-processed object and achieve a low water content suitable for a dried food.

Here, the temperature is set in the range of 45 to 100° C. and more preferably in the range of 50 to 90° C. Furthermore, when the temperature range is set to no less than 70° C., dried noodles of good texture can be provided and the merit that the hot wind drying treatment can be performed while reliably restraining the proliferation of coliform bacteria and general bacteria is provided.

If the wind speed in third step P₃ is too low, the dried product that is obtained in the final stage tends to change to a glassy appearance and it is difficult to achieve the desired deformation and formation of cracks and voids. If a wind speed of approximately 2 m/sec can be secured, the desired deformation and formation of cracks and voids can be achieved in the dried product that is obtained in the final stage and the final quality will also be good.

On the other hand, if the wind speed in third step P₃ is excessive, such problems as the product shape becoming defective due to the influence of wind pressure, inefficiency of energy, etc., occur. The upper limit wind velocity with which such problems do not occur should thus be selected in performing the wind drying.

Also if the wind is concentrated on a specific portion of the to-be-processed object, not only does drying become non-uniform but the portion onto which the wind is concentrated may flow or waver in the direction of the wind, and if this portion dries as it is, it becomes a shape defect.

Because it is thus desirable to make wind of a favorable wind speed condition pass through the entirety of the to-be-processed object uniformly, measures in terms of apparatus and condition settings that can realize this are selected in performing the wind drying in the present invention.

In performing wind drying, as to how much the weight after drying is to be made with respect to the weight before drying within a predetermined time is an extremely important point. As a result of diligent research by the inventor and others, it was found that wind drying the to-be-processed object rapidly in a short time is an important factor for forming cracks and voids in the dried product that is the final product.

Put in another way, if a long time is spent for wind drying, it becomes difficult to make effective use of the difference of progress of lowering of water content (the difference of progress of drying) between the surface and the interior of the to-be-processed object to form cracks and voids adequately in the dried food.

Also because to maintain a wind drying efficiency of a high level in this third step P₃, it is important to maintain a low humidity environment in the dryer or drying chamber, etc., wind drying by a non-circulating method and/or under a dehumidified environment is preferably carried out in this third step P₃, and these methods may be combined as suited.

In the case where these wind drying methods are employed, because the air that is used once is not used repeatedly and a low humidity can be maintained reliably, the wind drying efficiency is improved and the proliferation of microorganisms in the dryer or drying chamber can be restrained.

### EXAMPLES

<Verification Test of the “Boiling Time” in the First Step (Boiling Treatment Step)>

A purpose of this verification test is to examine the effects of the duration of the boiling treatment in the first step on the final product and select a favorable boiling time.

In this test, a noodle ribbon was prepared using 3 kg of semi-strong wheat flour as 100 weight parts, adding and mixing 1 weight part of table salt, 1 weight part of brine powder, 0.05 weight parts of a pigment, and 35 weight parts of water to the flour, and then performing rolling. The noodle ribbon obtained was then shaped with a No. 20 slitter (noodle thickness: 1.25 mm), a No. 16 slitter (noodle thickness 1.15 mm), and a No. 16 slitter for thick noodles (noodle thickness: 1.40 mm) to form raw noodle strings as the to-be-processed objects.

Each of the to-be-processed objects was subject to steaming treatment (heating treatment step) at 100° C. for 3 minutes, and in the first step (boiling treatment), the duration in hot water of approximately 100° C. was varied in the range of 1 to 5 minutes or 1 to 6 minutes. Immediately thereafter, each to-be-processed object was contacted with cold water, then batched off in suitable amounts, and left to stand for 1 hour under an indoor environment of 20 degrees. The noodles were then water rinsed and unraveled with tap water at 20° C. The water was then drained off and wind drying (third step) at conditions of 60° C. temperature and 20% humidity was performed for approximately 1 hour and a half.

60 g of the dried noodles thus obtained were transferred into a cup, which was covered after pouring in hot water of approximately 100° C. The cup was uncovered after 4 minutes in the case of dried noodles obtained with the No. 20 and No. 16 slitters and after 5 minutes in the case of dried noodles of obtained with the No. 16 slitter for thick noodles, and the state of noodle strings, the taste, and the unraveling property were evaluated.

10 panelists of abundant experience performed an evaluation according to the three grades of good ( [symbol] ), somewhat poor (Δ), and poor (x). The “state of noodle strings” was evaluated comprehensively in terms of the four points of powderiness, hardness, stickiness, and color tone, and the “taste” was evaluated comprehensively in terms of the two points of “flavor” and “texture.” The evaluation results are shown in the following “Table 1.”

TABLE 1

| | Noodles shaped by No. 20 | | | Noodles shaped by No. 16 | | | Noodles shaped by No. 16 | | |
|---|---|---|---|---|---|---|---|---|---|
| | slitter | | | slitter | | | slitter for thick noodles | | |
| Boiling | State | Quality | | State | Quality | | State | Quality | |
| time in | of | evaluation | | of | evaluation | | of | evaluation | |
| first | noodle | | Unraveling | noodle | | Unraveling | noodle | | Unraveling |
| step | strings | Taste | property | strings | Taste | property | strings | Taste | property |
| 1 | x | x | x | x | x | x | x | x | x |
| minute | | | | | | | | | |
| 2 | [symbol] | [symbol] | [symbol] | [symbol] | [symbol] | [symbol] | Δ | Δ | Δ |
| minutes | | | | | | | | | |
| 3 | [symbol] | [symbol] | [symbol] | [symbol] | [symbol] | [symbol] | [symbol] | [symbol] | [symbol] |
| minutes | | | | | | | | | |
| 4 | [symbol] | [symbol] | [symbol] | [symbol] | [symbol] | [symbol] | [symbol] | [symbol] | [symbol] |
| minutes | | | | | | | | | |
| 5 | x | x | x | Δ | x | x | [symbol] | [symbol] | [symbol] |
| minutes | | | | | | | | | |

| | | | | | | | |
|---|---|---|---|---|---|---|---|
| 6 | Not evaluated. | x | x | x | Δ | Δ | [symbol] |
| minutes | | | | | | | |

As indicated in “Table 1” above, it was confirmed that the length of the “boiling time” in the first step influences the state of noodle string, the taste, and the unraveling property. With the noodles prepared with the No. 20 and No. 16 slitters, boiling treatment for 2 to 4 minutes is favorable. When the boiling time is less than 2 minutes, the texture is such that a core remains and the unraveling property is poor. In the excess of 4 minutes, stickiness arises, the texture is too soft, and the unraveling property worsens.

For the noodles prepared with the No. 16 slitter for thick noodles, boiling treatment for 3 to 5 minutes is favorable. With less than 3 minutes, the noodle strings separated apart excessively and the texture is powdery. In the excess of 5 minutes, stickiness arises and the texture tends to be non-chewy.

### <Verification Test of the Time of the Steaming Treatment Step>

A purpose of this test is to examine the effect that the duration of the steaming treatment has on quality and to select a favorable steaming treatment time in the case where a manufacturing process of carrying out the steaming treatment step before the first step (boiling treatment) is employed.

In this test, a noodle ribbon of 1.4 mm thickness was prepared using 3 kg of semi-strong wheat flour as 100 weight parts, adding and mixing 1 weight part of table salt, 1 weight part of brine powder, 0.05 weight parts of a pigment, and 35 weight parts of water to the flour, and then performing rolling, and this noodle ribbon was shaped with a No. 16 slitter for rectangular noodles to form raw noodle strings as the to-be-processed objects.

The raw noodle strings were subject to steaming treatment (heating treatment step) at 100° C. temperature with the duration being varied in the range of 1 to 7 minutes, and thereafter subject to the boiling treatment at a temperature of approximately 100° C. for 3 minutes. Immediately thereafter, the to-be-processed object was contacted with cold water, then batched off in suitable amounts, and left to stand for 1 hour under an indoor environment of 20° C. The noodles were then water rinsed and unraveled with tap water at 20° C. The water was then drained off and the third step (wind drying step) was entered immediately thereafter. The wind drying conditions were 60° C. temperature and 20% humidity and the drying time was 1 hour and a half.

60 g of the dried noodles (Chinese noodles) thus obtained were transferred into a cup, which was covered after pouring in hot water of approximately 100° C. The cup was uncovered after 5 minutes, and the state of noodle strings, the taste, and the unraveling property at that point were evaluated.

10 panelists of abundant experience performed an evaluation according to the three grades of good [symbol] , somewhat poor (Δ), and poor (x). The “state of noodle strings” was evaluated comprehensively in terms of the four points of powderiness, hardness, stickiness, and color tone, and the “taste” was evaluated comprehensively in terms of the two points of “flavor” and “texture.” The evaluation results are shown in the following “Table 2.”

TABLE 2

| | Product evaluation | | |
|---|---|---|---|
| | | Quality evaluation | |
| Steaming | | | Unraveling |
| treatment time | State of noodle strings | Taste | property |
| 1 minute | Δ | Δ | x |
| 2 minutes | [symbol] | [symbol] | [symbol] |
| 3 minutes | [symbol] | [symbol] | [symbol] |
| 4 minutes | [symbol] | [symbol] | [symbol] |
| 5 minutes | Δ | Δ | Δ |
| 6 minutes | Δ | Δ | Δ |
| 7 minutes | x (Color tone became brownish.) | x | x |

It was thus made clear that in the case where a manufacturing process of performing the “heat steam treatment step” before the first step (boiling treatment step) is employed, the state of noodle strings and the quality (taste and unraveling property) are influenced by how the duration of the steaming treatment is selected. It was found that a steaming treatment time of 2 to 4 minutes is especially favorable.

<Verification Test of the “Standing Time” in the Standing Step>

A purpose of this test is to select a favorable standing time for the case where a manufacturing process in which the standing step is carried out is employed.

In this test, a noodle ribbon of 1.15 mm thickness was prepared using 3 kg of semi-strong wheat flour as 100 weight parts, adding and mixing 1 weight part of table salt, 1 weight part of brine powder, 0.05 weight parts of a pigment, and 35 weight parts of water to the flour, and then performing rolling, and this noodle ribbon was shaped using a No. 16 slitter for rectangular noodles to form raw noodle strings as the to-be-processed objects.

The raw noodle strings were subject to the steaming treatment (heating treatment step) at 100° C. temperature for 3 minutes, subject to 3 minutes of the boiling treatment by hot water at a temperature of approximately 100° C., and immediately thereafter contacted with cold water and batched off in suitable amounts. The subsequent standing step was carried out by letting the noodle strings stand under an indoor environment of 20° C. with the standing time being set to 0 minutes, 30 minutes, 1 hour, 3 hours, 6 hours, 10 hours, 15 hours, and 24 hours. After the standing step, the noodle lumps were water rinsed with tap water at 20° C. The water was then drained off and the third step (wind drying step) was entered. The wind drying was performed under conditions of 60° C. temperature and 20% humidity for 1 hour and a half.

60 g each of the respective dried noodles (Chinese noodles) thus obtained were transferred into a cup, which was covered after pouring in hot water of approximately 100° C. The cup was uncovered after 4 minutes, and the taste and the unraveling property at that point were evaluated.

10 panelists of abundant experience performed an evaluation according to the three grades of good ( [symbol] ), somewhat poor (Δ), and poor (x). The “taste” was evaluated comprehensively in terms of the two points of “flavor” and “texture.” The evaluation results are shown in the following “Table 3.”

TABLE 3

| | Quality evaluation | |
|---|---|---|
| Standing time | Taste | Unraveling property |
| 0 minutes (no standing) | x | x |
| 30 minutes | Δ | Δ |
| 1 hour | [symbol] | [symbol] |
| 3 hours | [symbol] | [symbol] |
| 6 hours | [symbol] | [symbol] |
| 10 hours | [symbol] | [symbol] |
| 15 hours | [symbol] | [symbol] |
| 24 hours | Δ (However, the color | [symbol] |
| | tone became | |
| | somewhat dull.) | |

As indicated in “Table 3” above, though the standing time under an indoor environment may be as long as 10 hours or 15 hours, 1 to 6 hours is favorable in consideration of quality, productivity, etc. It was also found that if the problem of dulling of the color tone is disregarded, standing for approximately 24 hours can also be employed. It has also become clear that when the standing time is less than 1 hour, hardness is felt in terms of texture and the unraveling property becomes poor.

<Verification Test Concerning Setting of Conditions of the Second Step (Aqueous Solution Contacting Step)>

A purpose of this test is to select favorable conditions of temperature and processing time for the second step (aqueous solution contacting step).

In this test, a noodle ribbon was prepared using 3 kg of semi-strong wheat flour as 100 weight parts, adding and mixing 1 weight part of table salt, 1 weight part of brine powder, 0.05 weight parts of a pigment, and 35 weight parts of water to the flour, and then performing rolling. This noodle ribbon was shaped using a No. 20 slitter for rectangular noodles (noodle thickness: 1.25 mm) to form raw noodle strings as the to-be-processed objects.

The raw noodle strings were subject to the steaming treatment (heating treatment step) at 100° C. temperature for 3 minutes, subject to 3 minutes of the boiling treatment by hot water at a temperature of approximately 100° C., immediately thereafter contacted with cold water, and then contacted with (immersed in) aqueous solutions of 5° C., 25° C., and 55° C., respectively. Water was then drained off and the third step (wind drying step) was entered. The wind drying was performed for 1 hour and a half under conditions of 60° C. temperature and 20% humidity.

60 g each of the respective dried noodles (Chinese noodles) thus obtained were transferred into a cup, which was covered after pouring in hot water of approximately 100° C. The cup was uncovered after 4 minutes, and the taste and the unraveling property at that point were evaluated.

10 panelists of abundant experience performed an evaluation according to the three grades of good ( [symbol] ), somewhat poor (Δ), and poor (x). The “taste” was evaluated comprehensively in terms of the two points of “flavor” and “texture.” The evaluation results are shown in the following “Table 4.”

TABLE 4

| | Temperature of aqueous solution | | | | | |
|---|---|---|---|---|---|---|
| | | | 25° C. | | | |
| | 5° C. | | | Unrav- | 55° C. | |
| Contacting | | Unraveling | | eling | | Unraveling |
| time | Taste | property | Taste | property | Taste | property |
| 5 minutes | x | x | x | x | x | Δ |
| 15 minutes | x | x | x | Δ | Δ | [symbol] |
| 30 minutes | Δ | x | [symbol] | [symbol] | [symbol] | [symbol] |
| 1 hour | Δ | [symbol] | [symbol] | [symbol] | [symbol] | [symbol] |
| 2 hours | [symbol] | [symbol] | [symbol] | [symbol] | [symbol] | [symbol] |
| 3 hours | [symbol] | [symbol] | [symbol] | [symbol] | [symbol] | [symbol] |
| 4 hours | [symbol] | [symbol] | [symbol] | [symbol] | [symbol] | [symbol] |
| 6 hours | [symbol] | [symbol] | [symbol] | [symbol] | [symbol] | Δ |
| 10 hours | [symbol] | [symbol] | [symbol] | [symbol] | Δ | Δ |
| 15 hours | [symbol] | [symbol] | [symbol] | [symbol] | Δ | x |
| 24 hours | [symbol] | [symbol] | x | Δ | x | X |

As indicated in “Table 4” above, it became clear that contact for 1 to 24 hours is favorable with the aqueous solution of 5° C., contact for 30 minutes to 15 hours is favorable with the aqueous solution of 25° C., and contact for 15 minutes to approximately 6 hours is favorable with the aqueous solution of 55° C. Though depending on the immersion temperature and other conditions, dried noodles of good quality can be obtained even with aqueous solution contact exceeding 6 hours, this is not practical in terms of productivity, sanitation, etc.

When the second step (aqueous solution contacting step) is performed under such conditions, water content gradient adjustment of the to-be-processed object (noodles) is carried out adequately, doing away with the need for performing the standing step under an indoor environment in a subsequent step.

As a result of a supplementary test, it was found that in the case of contact with an aqueous solution of 70° C., though the weight increase was maximized in a short time, the noodle string surface began to roughen and the surface became sticky readily.

<Verification Test Concerning Drying Time, Humidity Condition, etc., in the Third Step>

A purpose of this test is to examine the drying time, humidity condition, etc., in the third step and to select favorable wind drying conditions.

In this test, a noodle ribbon of 1.40 mm thickness was prepared using 3 kg of semi-strong wheat flour as 100 weight parts, adding and mixing 1 weight part of table salt, 1 weight part of brine powder, 0.05 weight parts of a pigment, and 35 weight parts of water to the flour, and then performing rolling, and this noodle ribbon was shaped to thick noodles using a No. 16 slitter for rectangular noodles to obtain raw noodle strings as the to-be-processed objects.

The raw noodle strings were subject to the steaming treatment (heating treatment step) at 100° C. temperature for 3 minutes, subject to 3 minutes of the boiling treatment by hot water at a temperature of approximately 100° C., immediately thereafter contacted with cold water, then batched off in suitable amounts, and left standing for 1 hour under an indoor environment of 20° C. Water rinsing and unraveling with tap water of 20° C. was then performed. The water was then drained off and the third step (wind drying step) was entered immediately. The wind drying was performed under conditions of 50° C. temperature and 10%, 30%, 50%, and 70% humidity, respectively.

60 g each of the respective dried noodles (Chinese noodles) thus obtained were transferred into a cup, which was covered after pouring in hot water of approximately 100° C. The cup was uncovered after 5 minutes, and the state of noodle strings, the taste, and the unraveling property at that point were evaluated.

10 panelists of abundant experience performed a comprehensive evaluation of the “state of noodle strings (powderiness, hardness, stickiness, and color tone), ”taste (flavor and texture),” and “unraveling property” according to the three grades of good ( [symbol] ), somewhat poor (Δ), and poor (x). The evaluation results are shown in the following “Table 5,” and drying curves drawn from the data of “Table 5” are shown in the attached FIG. 2.

TABLE 5

| | | | | | | | | Comparative | |
|---|---|---|---|---|---|---|---|---|---|
| | | Example A | | Example B | | Example C | | Example A | |
| | | Temperature | | | | | | | |
| | | 50° C. | | | | | | | |
| | | Humidity | | | | | | | |
| | | 10% | | 30% | | 50% | | 70% | |
| | | | Weight | | Weight | | Weight | | Weight |
| | | Weight | percentage | Weight | percentage | Weight | percentage | Weight | percentage |
| | | (g) | (%) | (g) | (%) | (g) | (%) | (g) | (%) |
| Drying time | 0 | 241.3 | — | 242.5 | — | 233.1 | — | 239.4 | — |
| (minutes) | 10 | 177.8 | 73.6 | 206.3 | 85.0 | 209.4 | 89.8 | 228.1 | 95.2 |
| | 20 | 137.2 | 56.8 | 161.3 | 66.5 | 177.2 | 76.0 | 210.9 | 88.0 |
| | 30 | 105.0 | 43.5 | 118.4 | 48.8 | 143.4 | 61.5 | 191.3 | 79.9 |
| | 40 | 84.4 | 34.9 | 94.7 | 39.0 | 114.1 | 48.9 | 168.8 | 70.0 |
| | 50 | 73.8 | 30.5 | 80.0 | 32.9 | 92.8 | 39.8 | 147.5 | 61.6 |
| | 60 | 68.1 | 28.2 | 72.2 | 29.8 | 79.4 | 34.0 | 126.6 | 52.8 |
| | 70 | 65.3 | 27.0 | 67.5 | 27.8 | 71.6 | 30.7 | 109.1 | 45.4 |
| | 80 | 63.8 | 26.4 | 65.6 | 27.0 | 67.2 | 28.8 | 94.7 | 39.5 |
| | 90 | | | 64.1 | 26.4 | 64.7 | 27.7 | 84.7 | 35.3 |
| | 100 | | | 62.9 | 25.9 | 63.4 | 27.1 | 76.9 | 32.1 |
| | 110 | | | | | 62.5 | 26.8 | 72.2 | 30.1 |
| | 120 | | | | | | | 68.4 | 28.5 |
| | 130 | | | | | | | 66.9 | 27.9 |
| | 140 | | | | | | | 65.9 | 27.5 |
| | 150 | | | | | | | 65.0 | 27.1 |
| | 160 | | | | | | | 64.4 | 26.9 |
| | 170 | | | | | | | 64.0 | 26.7 |
| | 180 | | | | | | | 63.4 | 26.4 |

| | | | | |
|---|---|---|---|---|
| Evaluation | [symbol] | [symbol] | [symbol] | x |

As a result of this test, it was found that how much the weight after drying is to be made with respect to the weight before drying within a predetermined time is an extremely important point in the third step (wind drying step). That is, it was found that wind drying the to-be-processed object rapidly in a short time is an important factor for forming cracks and voids in the dried product that is the final product.

As indicated in “Table 5” above and in the attached FIG. 2, it was found to be desirable to perform rapid wind drying such that the weight falls to no more than 50% of the weight before drying within 40 minutes from the start of the third step (wind drying step) and to no more than 35% of the weight before drying within 60 minutes.

Also as a result of this test, it became clear that noodles of the desired level of quality cannot be obtained at a humidity of 70% (Comparative Example A) (see “Table 5”).

The water contents of the dried noodles of Example A, Example B, Example C, and Comparative Example A were 11.3%, 11.8%, 11.0%, and 11.1%, respectively.

<Verification Test Concerning Temperature and Humidity Conditions of the Third Step (Wind Drying Step)>

A purpose of this test is to select favorable temperature and humidity conditions for the third step.

In this test, noodle ribbons were respectively prepared using 3 kg of semi-strong wheat flour as 100 weight parts, adding and mixing 1 weight part of table salt, 1 weight part of brine powder, 0.05 weight parts of a pigment, and 35 weight parts of water to the flour and then rolling to a thickness of 1.25 mm in the case of using a No. 20 slitter for rectangular noodles, to a thickness of 1.15 mm in the case of using a No. 16 slitter for rectangular noodles, and to a noodle thickness of 1.40 mm in the case of using a No. 16 slitter for rectangular noodles to form thick noodles, and the noodle ribbons were shaped correspondingly to obtain raw noodle strings as the to-be-processed objects.

The raw noodle strings were respectively subject to the steaming treatment (heating treatment step) at 100° C. temperature for 3 minutes, subject to 3 minutes of the boiling treatment by hot water at a temperature of approximately 100° C., immediately thereafter contacted with cold water, then batched off in suitable amounts, and left standing for 1 hour under an indoor environment of 20° C. Water rinsing with tap water of 20° C. was then performed. The water was then drained off and the third step (wind drying step) was entered. The wind drying was performed under conditions of 80° C. temperature and 30% humidity and under conditions of 90° C. temperature and 20% humidity.

60 g each of the respective dried noodles (Chinese noodles) thus obtained were transferred into a cup, which was covered after pouring in hot water of approximately 100° C. The cup was uncovered after 4 minutes in the case of noodles prepared with the No. 20 and No. 16 slitters and after 5 minutes in the case of noodles prepared with the No. 16 slitter for thick noodles, and the “taste” and the “unraveling property” at that point were evaluated.

10 panelists of abundant experience performed an evaluation according to the three grades of good ( [symbol] ), somewhat poor (Δ), and poor (x). The “taste” was evaluated comprehensively in terms of the two points of “flavor” and “texture.” The evaluation results are shown in the following “Table 6.”

TABLE 6

| | | | | | Comparative | | | | | | Comparative | |
|---|---|---|---|---|---|---|---|---|---|---|---|---|
| | Example 1 | | Example 2 | | Example 1 | | Example 3 | | Example 4 | | Example 2 | |
| | Temperature 80° C. | | | | | | Temperature 90° C. | | | | | |
| | Humidity 20% | | Humidity 30% | | Humidity 55% | | Humidity 20% | | Humidity 30% | | Humidity 55% | |
| | | Unraveling | | Unraveling | | Unraveling | | Unraveling | | Unraveling | | Unraveling |
| | Taste | property | Taste | property | Taste | property | Taste | property | Taste | property | Taste | property |
| No. 20 | [symbol] | [symbol] | [symbol] | [symbol] | x | x | [symbol] | [symbol] | [symbol] | [symbol] | x | x |
| noodles | | | | | | | | | | | | |
| No. 16 | [symbol] | [symbol] | [symbol] | [symbol] | x | x | [symbol] | [symbol] | [symbol] | [symbol] | x | x |
| noodles | | | | | | | | | | | | |
| No. 16 | [symbol] | [symbol] | [symbol] | [symbol] | x | x | Δ | [symbol] | Δ | [symbol] | x | x |
| thick | | | | | | | | | | | | |
| noodles | | | | | | | | | | | | |

As indicated in “Table 6” above, whereas under the respective conditions of 80° C. temperature and 20% humidity (Example 1) and 80% temperature and 30% humidity (Example 2), the taste and the unraveling property were evaluated to be good regardless of the thickness of noodle strings, under the condition of 80% temperature and 55% humidity (Comparative Example 1), the taste and the unraveling property were evaluated to be poor.

Also, with the respective conditions of 90° C. temperature and 20% humidity (Example 3) and 90% temperature and 30% humidity (Example 4), though, in regard to taste, the texture tended to be somewhat hard in comparison to noodles prepared at 80° C. temperature, good evaluations were obtained. On the other hand, under the condition of 90% temperature and 55% humidity (Comparative Example 2), the taste and the unraveling property were evaluated to be poor.

It thus became clear that dried noodles of good quality can be manufactured even under conditions of low humidity at a high temperature range of 80 to 90° C. temperature and that it is preferable to select a temperature condition of no more than 80° C. (see “Table 6”).

<Verification of Wind Speed Condition in the Third Step (Wind Drying Step)>

A purpose of this test is to examine and select favorable wind speed conditions for the third step (wind drying step).

In this test, a noodle ribbon of 1.40 mm thickness was prepared using 3 kg of semi-strong wheat flour as 100 weight parts, adding and mixing 1 weight part of table salt, 1 weight part of brine powder, 0.05 weight parts of a pigment, and 35 weight parts of water to the flour, and then performing rolling, and this noodle ribbon was shaped to thick noodles using a No. 16 slitter for rectangular noodles to obtain raw noodle strings as the to-be-processed objects.

The raw noodle strings were subject to the steaming treatment (heating treatment step) at 100° C. temperature for 3 minutes. Then immediately after subjecting to 3 minutes of the boiling treatment by hot water at a temperature of approximately 100° C., the noodle strings were contacted with cold water, batched off into suitable amounts, and then left to stand for 1 hour under an indoor environment of 20° C. Water rinsing and unraveling were then performed using tap water of 20° C. temperature. The water was then drained off and the third step (wind drying step) was entered immediately thereafter. For wind drying, the temperature was set to 50° C., the humidity was set to 30%, and just the wind speed was varied.

The wind speed was measured at a position of approximately 2.0 cm below a bottom portion of a retainer, which holds a noodle lump, before the noodle lump was set. The hybrid anemometer DP07, made by Hiyoshi Electric Manufacturing Co., Ltd., was used to measure the wind speed.

60 g each of the respective dried noodles (Chinese noodles) obtained as a result of wind drying were transferred into a cup, which was covered after pouring in hot water of approximately 100° C. The cup was uncovered after 5 minutes, and the “taste” and the “unraveling property” at that point were evaluated.

10 panelists of abundant experience performed an evaluation according to the three grades of good ( [symbol] ), somewhat poor (Δ), and poor (x). The “taste” was evaluated comprehensively in terms of the two points of “flavor” and “texture.” The evaluation results are shown in the following “Table 7.”

TABLE 7

Evaluation

| | Wind speed | | Unraveling |
|---|---|---|---|
| | (m/s) | Taste | property |
| Comparative Example a | 1.30 | Δ | X |
| Example a | 2.10 | [symbol] | [symbol] |
| Example b | 5.35 | [symbol] | [symbol] |
| Example c | 6.18 | [symbol] | [symbol] |
| Example d | 6.33 | [symbol] | [symbol] |

As indicated by “Table 7” above, it is difficult to form voids and cracks in the noodle strings in the dried state with a slight breeze condition of a wind speed of approximately 1.30 m/s. On the other hand, it was made clear that when the wind speed condition is set to a wind speed of approximately 2.10 m/s, voids and cracks are formed in the noodle strings in the dried state.

These results show that when dried noodle strings in which voids and cracks are formed are reconstituted in hot water, the “taste” and “unraveling property” are extremely good (see “Table 7”).

<Verification Test of Textural Structure or Form Characteristics of the Dried Food that is the Final Product>

A purpose of this test is to confirm the textural structure or form characteristics of dried foods obtained by the manufacturing method according to the present invention using an electron microscope.

The analysis of this test was carried out using a field emission scanning electron microscope (S-800, made by Hitachi, Ltd.) to observe SEM images (images obtained by converting variations in secondary electron amount due to unevenness to luminance) of width direction cross sections of dried noodles that are the samples. The acceleration voltage was set to 6.0 kV.

In this test, a noodle ribbon of 1.40 mm thickness was prepared using 3 kg of semi-strong wheat flour as 100 weight parts, adding and mixing 1 weight part of table salt, 1 weight part of brine powder, 0.05 weight parts of a pigment, and 35 weight parts of water to the flour, and then performing rolling, and this noodle ribbon was shaped to thick noodles using a No. 16 slitter for rectangular noodles to obtain raw noodle strings as the to-be-processed objects.

The raw noodle strings were subject to the steaming treatment (heating treatment step) at 100° C. temperature for 3 minutes, and then immediately after subjecting to 3 minutes of the boiling treatment by hot water at a temperature of approximately 100° C., the noodle strings were contacted with cold water, batched off into suitable amounts, and then left to stand for 1 hour under an indoor environment of 20° C. Water rinsing and unraveling were then performed using tap water of 20° C. temperature. Noodles strings, which were then subject to water draining and then immediately thereafter to the third step (wind drying step), were used.

In regard to the wind drying conditions in the third step, the hot-air, low-humidity conditions of 80° C. temperature and 15% humidity were set for “Example I” and the hot-air, high-humidity conditions of 80° C. temperature and 70% humidity were set for “Comparative Example I,” and in both cases, wind drying was performed for 1 hour and a half.

In a supplementary test, 1 hour of wind drying under 80° C. temperature and 15% humidity was performed, and this resulted in the same results as described below.

FIG. 3 and FIG. 4 are enlarged electron micrographs (photographs substituting for drawings) of width direction cross sections of noodle strings of the abovementioned Example I, and FIG. 5 is an enlarged electron micrograph (photograph substituting for drawing) of a width direction cross section of a noodle string of the abovementioned Comparative Example I.

As can be understood from the attached FIG. 3 and FIG. 4, with “Example I,” voids are formed in the interior of the noodle sections, and cracks are present dispersedly in a range extending from the central portion to close to the surface of the noodle strings. Observation of the width direction cross sectional shapes of the noodle strings show that the noodle strings take on a dumbbell-like shape with a thinned portion being present at a central portion in the width direction.

On the other hand, as can be understood from FIG. 5, hardly any voids are formed in the section of the noodle with “Comparative Example I.” Though a few cracks can be seen in the range from the central portion to near the surface of the noodle string, these are significantly low in number and size in comparison to those of “Example I.” Also, a thinned portion of concave form, such as that seen in Example I, cannot be seen upon observation of the width direction cross sectional shape of the noodle string.

From the above, it is clear that the dried noodles obtained by the manufacturing method according to the present invention have unique characteristics in terms of textural structure or form.

This can be presumed to be because, when the noodle strings are supplied with water, adjusted to be small in the water content gradient between the surface and the central portion, and processed in advance to a non-sticking state in the first step (boiling treatment) and the second step (aqueous solution contact) and thereupon subject to the third step (wind drying step) to be wind dried under conditions of low humidity and medium to high temperature range, a difference arises in the progress of drying between the surface and the central portion of the noodle strings so that the surface, at which drying progresses quickly, solidifies at once ahead of the central portion, and as water is accompanyingly removed from the central portion that is slow in the progress of drying and is still in a soft state, a thinned portion is formed due to the internal portion being put in a depressurized state and deforming in the manner of being squashed by atmospheric pressure.

For example, in a case where the cross sectional shape in the width direction of a noodle string is rectangular (see “Example I”) or elliptical, a thinned portion is formed readily by the longitudinal surface portions of the cross section deforming concavely toward the central portion. It is presumed that when such a deformation occurs, cracks and voids are formed by shrinkage and distortion in the internal textural structure of the noodle string and that numerous voids are formed especially at the central portion at which the shrinkage and distortion are concentrated.

With dried noodles having such characteristics, the surface area of the entirety of each noodle string is increased by the forming of the thinned portion and the efficiency of contact of the noodle string with hot water is thereby improved significantly. The restoration of texture by hot water is also quickened via the abovementioned thinned portion.

Also, hot water permeates towards the central portion by the capillary phenomenon, etc., via the numerous cracks formed in the range between the central portion to the surface, and the entirety of each noodle string is thereby softened uniformly. Consequently, these dried noodles require a short time for hot water cooking or hot water reconstitution and can realize a texture extremely close to that of cooked raw noodles.

<Confirmation Test of the Deformation due to Wind Drying and the Cross-Sectional Shape of Noodles after Hot Water Reconstitution>

A purpose of this test is to prepare samples of different noodle string shapes (rectangular, elliptical, and circular) to confirm the state of deformation after wind drying and the change of cross-sectional shape of the noodles after hot water reconstitution.

In this test, cut sections of sample noodle strings were observed using a stereoscopic microscope (S6045TR-SCTV), made by Olympus Optical Co., Ltd. The magnification of measurement was 50 times (ocular lens: 10 times x objective lens: 5 times).

The respective samples thus prepared were immersed in boiling water for just the durations indicated in “Table 8”below and then subject to water draining immediately thereafter. Each noodle string was then immersed in ethanol and upon being taken out, cut perpendicularly to prepare a cut section in the width direction, and this cut section was observed by the above-described method.

The dried noodles used in this test were prepared using 3 kg of semi-strong wheat flour as 100 weight parts, and mixing 1 weight part of table salt, 1 weight part of brine powder, 0.05 weight parts of a pigment, and 35 weight parts of water to the flour. In the case of rectangular noodles of “Example i,” the dough was rolled to a noodle ribbon of 1.40 mm thickness and shaped to thick noodles using a No. 16 slitter for rectangular noodles to obtain raw noodle strings as the to-be-processed objects. The dough was rolled to a noodle ribbon of 0.95 mm thickness in the case of elliptical noodles of “Example ii” and to a noodle ribbon of 1.42 mm thickness in the case of circular noodles of “Comparative Example i” and in each of these cases, the noodle ribbon was then shaped with a No. 20 slitter for round noodles.

These raw noodle strings were subject to the steaming treatment (heating treatment step) at 100° C. temperature for 3 minutes, and then immediately after subjecting to the boiling treatment by hot water at a temperature of approximately 100° C. for durations according to the noodle string thickness, the noodle strings were contacted with cold water, batched off in suitable amounts, and then left to stand for 1 hour under an indoor environment of 20° C. Water rinsing and unraveling were then performed using tap water of 20° C. temperature. The water was then drained off and the third step (wind drying step) was performed immediately thereafter. The wind drying was performed under conditions of 60° C. temperature and 15% humidity. The boiling treatment durations were 3 minutes for Example i, 2 minutes for Example ii, and 2 minutes and 30 seconds for Comparative Example i.

The respective width-direction vertical sectional shapes of Example i, Example ii, and Comparative Example i employed in the present test are listed along with the Figure Nos. indicating the micrographs of the cross-sectional shapes of the respective examples corresponding to the respective points in time of measurement (see “Table 8”). Outlines are added to the respective micrographs to facilitate recognition of the outer shapes of the respective sections.

TABLE 8

| | | | Comparative |
|---|---|---|---|
| | Example i | Example ii | Example i |
| Cross sectional shape of | Rectangular | Elliptical | Circular |
| noodle string | | | |
| Immediately before drying | FIG. 6A | — | — |
| Immediately after drying | FIG. 6B | FIG. 7A | FIG. 8A |
| 1 minute after hot water | FIG. 6C | FIG. 7B | FIG. 8B |
| reconstitution | | | |
| 2 minutes after hot water | FIG. 6D | FIG. 7C | FIG. 8C |
| reconstitution | | | |
| 3 minutes after hot water | FIG. 6E | FIG. 7D | FIG. 8D |
| reconstitution | | | |
| 4 minutes after hot water | FIG. 6F | — | FIG. 8E |
| reconstitution | | | |
| 5 minutes after hot water | FIG. 6G | — | — |
| reconstitution | | | |
| 6 minutes after hot water | FIG. 6H | — | — |
| reconstitution | | | |

Firstly, with reference to the attached FIGS. 6A to 6H (photographs substituting for drawings), it can be seen that with the rectangular noodles of Example i, the cross-sectional shape of the noodles immediately before drying is rectangular (FIG. 6A). It can be seen that immediately after the wind drying step, a thinned portion of concave form is formed across the width direction so that the shape is deformed as a whole into a dumbbell-like form (see FIG. 6B).

Upon hot water reconstitution, the shape is gradually restored to the state before drying (FIGS. 6C to 6H). Because even after 4 minutes of hot water reconstitution, a core can no longer be seen at the central portion (see FIG. 6F), it can be understood that the hot water reconstitution is carried out adequately and rapidly. This is considered to be due to the promotion of heat transfer and hot water permeation to the central portion by the provision of the thinned portion.

Next, with reference to the attached FIGS. 7A to 7D (photographs substituting for drawings), it can be seen that with the elliptical noodles of Example ii, a thinned portion of concave form is formed in the noodle immediately after drying (see FIG. 7A).

Upon hot water reconstitution, the shape is gradually restored to the state before drying (FIGS. 7B to 7D). Because even after 3 minutes of hot water reconstitution, a core can no longer be seen at the central portion (see FIG. 7D), it can be understood that the hot water reconstitution is carried out rapidly. This is considered to be due to the promotion of heat transfer and hot water permeation to the central portion by the provision of the thinned portion in the same manner as in Example i.

As shown in the FIGS. 8A to 8D (photographs substituting for drawings), with the circular noodles of Comparative Example i, only a few small depressions are formed in the noodles immediately after drying and, unlike Example i and Example ii, a thinned portion, which forms a concave shape at a central position in the width direction, was not seen (FIG. 8A). This can be presumed to be because with a circular noodle, the evaporation of water occurring uniformly and distortions thus do not occur in the wind drying step.

It can be seen that even with the circular noodles, the shape gradually returns to the state before drying upon hot water reconstitution (see FIGS. 8B to 8E). However, it can be clearly seen that a core (clouded portion) remains at the central portion even after 4 minutes of hot water reconstitution (FIG. 8E). This can be presumed to be due to the heat transfer and hot water permeation to the central portion being slow because a thinned portion is not formed after wind drying.

It is clear from the above test results that when the width direction cross section of a noodle string is rectangular or elliptical, hot water reconstitution takes place adequately and rapidly in the hot water reconstitution process. Noodle strings having a width direction cross section of rectangular or elliptical shape are thus favorable as instant noodles that are required to have an instant preparation property.

### INDUSTRIAL APPLICABILITY

The present invention can be used to provide a method for manufacturing various dried foods designed to be restored in texture and flavor suited for eating by cooking or reconstitution in hot water. The invention can be used in a method for manufacturing non-fried instant noodles, fried instant noodles, dry noodles, pasta, macaroni, bean-starch vermicelli, rice noodles, etc.

The dried noodles according to the present invention are favorable, for example, as non-fried instant noodles because these noodles enable shortening of the time required for hot water cooking or hot water reconstitution and provide a texture extremely close to cooked raw noodles.

### BRIEF DESCRIPTION OF THE DRAWINGS

FIG. 1 is a process flow diagram of a preferred embodiment of a dried food manufacturing method according to the present invention;

FIG. 2 is a diagram of drying curves drawn from data of “Table 5”;

FIG. 3 is an enlarged electron micrograph (photograph substituting for drawing) of a width direction cross section of a noodle string of a dried noodle (Example I) according to the present invention;

FIG. 4 is another enlarged electron micrograph (photograph substituting for drawing) of a width direction cross section of a noodle string of a dried noodle (Example I) according to the present invention;

FIG. 5 is an enlarged electron micrograph (photograph substituting for drawing) of a width direction cross section of a noodle string of a comparative example;

FIG. 6A is an enlarged stereoscopic micrograph (photograph substituting for drawing) of a width direction cross section of a rectangular noodle (Example i) immediately before drying;

FIG. 6B is an enlarged stereoscopic micrograph (photograph substituting for drawing) of a width direction cross section of a rectangular noodle (Example i) immediately after drying;

FIG. 6C is an enlarged stereoscopic micrograph (photograph substituting for drawing) of a width direction cross section of a rectangular noodle (Example i) after 1 minute of hot water reconstitution;

FIG. 6D is an enlarged stereoscopic micrograph (photograph substituting for drawing) of a width direction cross section of a rectangular noodle (Example i) after 2 minutes of hot water reconstitution;

FIG. 6E is an enlarged stereoscopic micrograph (photograph substituting for drawing) of a width direction cross section of a rectangular noodle (Example i) after 3 minutes of hot water reconstitution;

FIG. 6F is an enlarged stereoscopic micrograph (photograph substituting for drawing) of a width direction cross section of a rectangular noodle (Example i) after 4 minutes of hot water reconstitution;

FIG. 6G is an enlarged stereoscopic micrograph (photograph substituting for drawing) of a width direction cross section of a rectangular noodle (Example i) after 5 minutes of hot water reconstitution;

FIG. 6H is an enlarged stereoscopic micrograph (photograph substituting for drawing) of a width direction cross section of a rectangular noodle (Example i) after 6 minutes of hot water reconstitution;

FIG. 7A is an enlarged stereoscopic micrograph (photograph substituting for drawing) of a width direction cross section of an elliptical noodle (Example ii) immediately after drying;

FIG. 7B is an enlarged stereoscopic micrograph (photograph substituting for drawing) of a width direction cross section of an elliptical noodle (Example ii) after 1 minute of hot water reconstitution;

FIG. 7C is an enlarged stereoscopic micrograph (photograph substituting for drawing) of a width direction cross section of an elliptical noodle (Example ii) after 2 minutes of hot water reconstitution;

FIG. 7D is an enlarged stereoscopic micrograph (photograph substituting for drawing) of a width direction cross section of an elliptical noodle (Example ii) after 3 minutes of hot water reconstitution;

FIG. 8A is an enlarged stereoscopic micrograph (photograph substituting for drawing) of a width direction cross section of a circular noodle (Comparative Example i) immediately after drying;

FIG. 8B is an enlarged stereoscopic micrograph (photograph substituting for drawing) of a width direction cross section of a circular noodle (Comparative Example i) after 1 minute of hot water reconstitution;

FIG. 8C is an enlarged stereoscopic micrograph (photograph substituting for drawing) of a width direction cross section of a circular noodle (Comparative Example i) after 2 minutes of hot water reconstitution;

FIG. 8D is an enlarged stereoscopic micrograph (photograph substituting for drawing) of a width direction cross section of a circular noodle (Comparative Example i) after 3 minutes of hot water reconstitution; and

FIG. 8E is an enlarged stereoscopic micrograph (photograph substituting for drawing) of a width direction cross section of a circular noodle (Comparative Example i) after 4 minutes of hot water reconstitution.

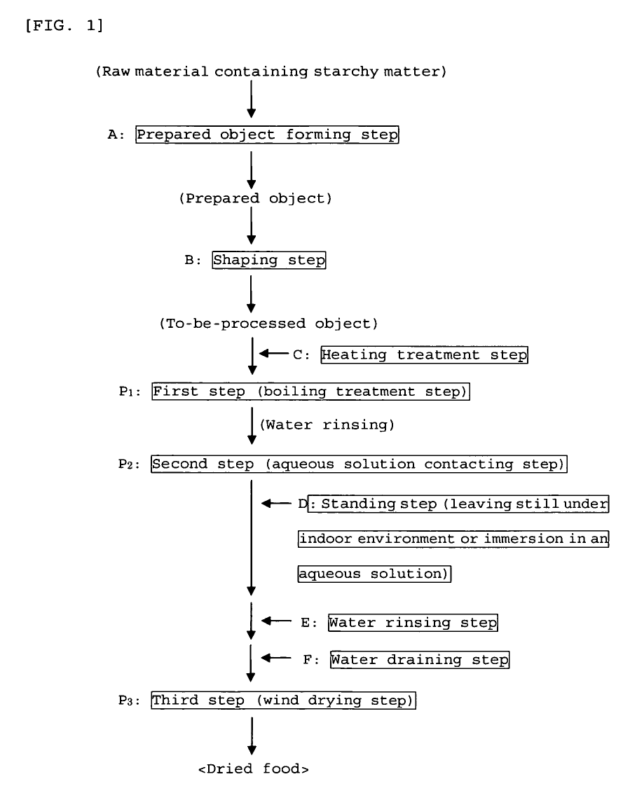

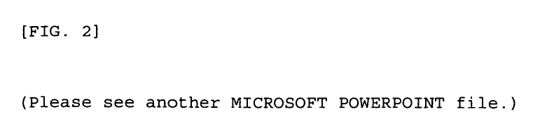

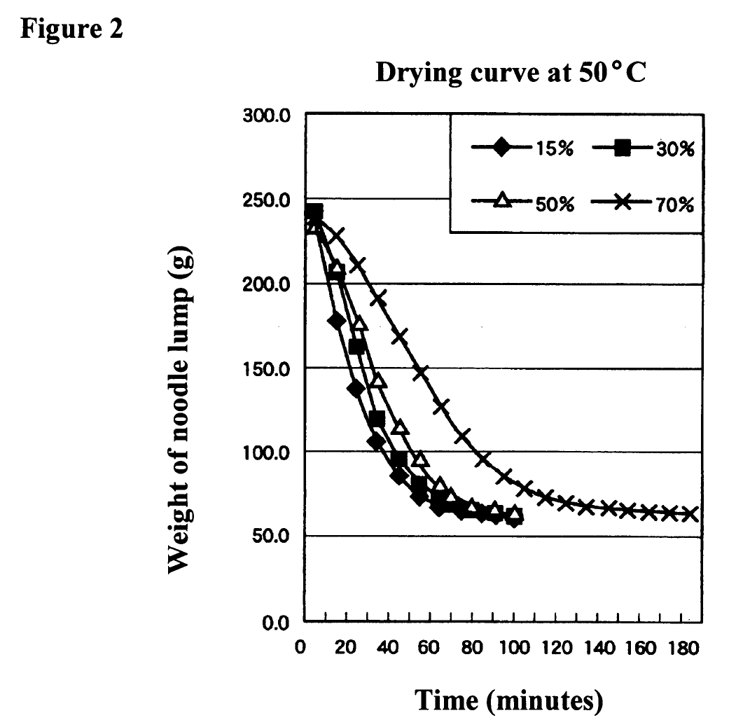

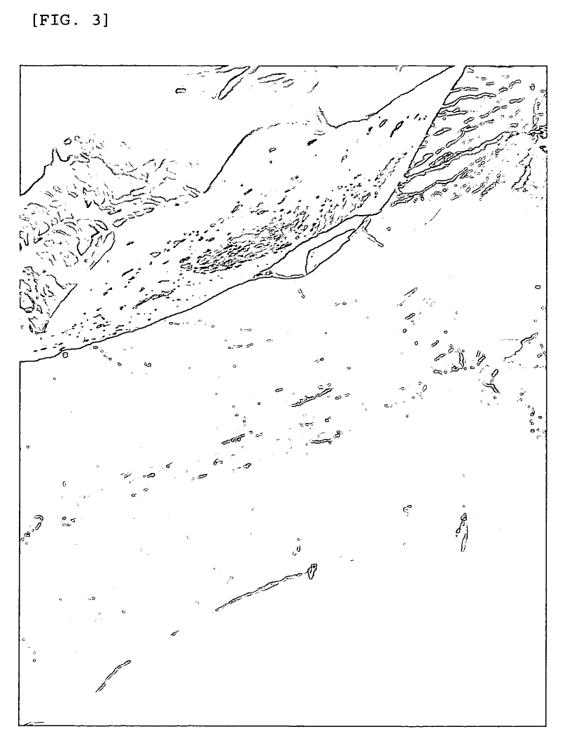

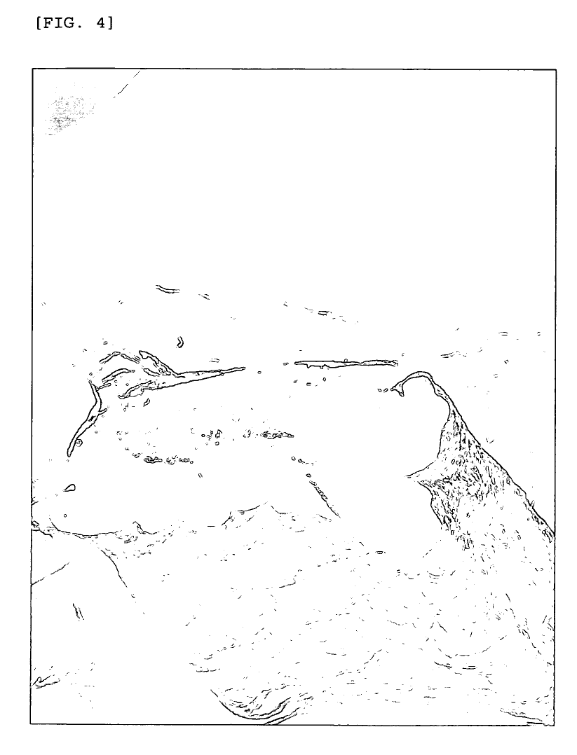

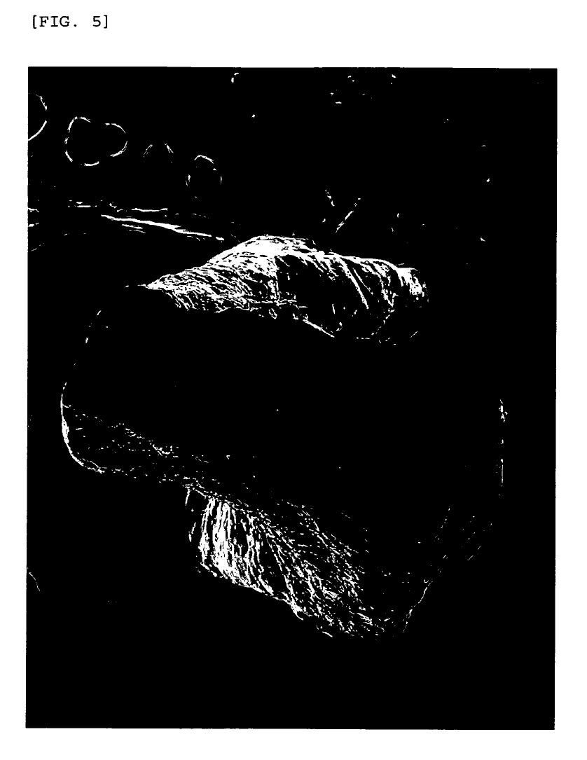

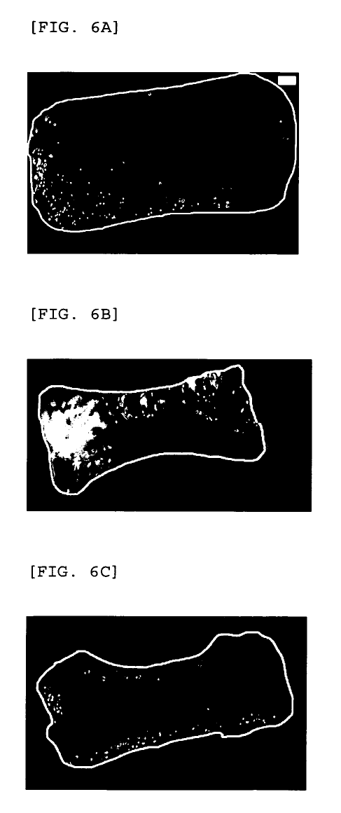

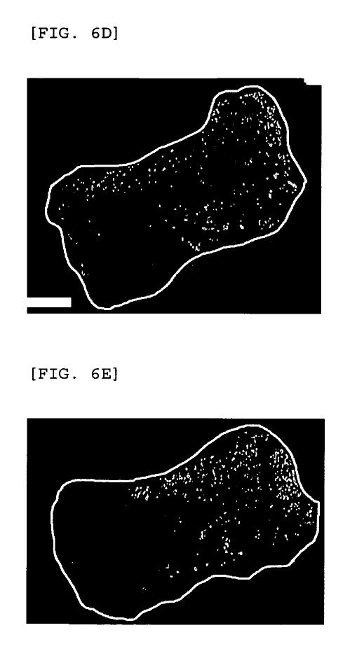

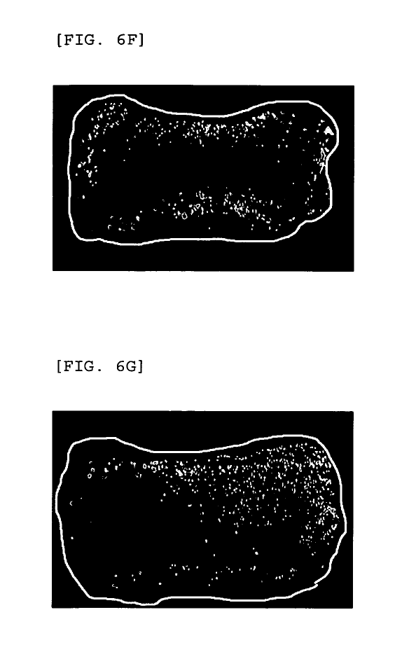

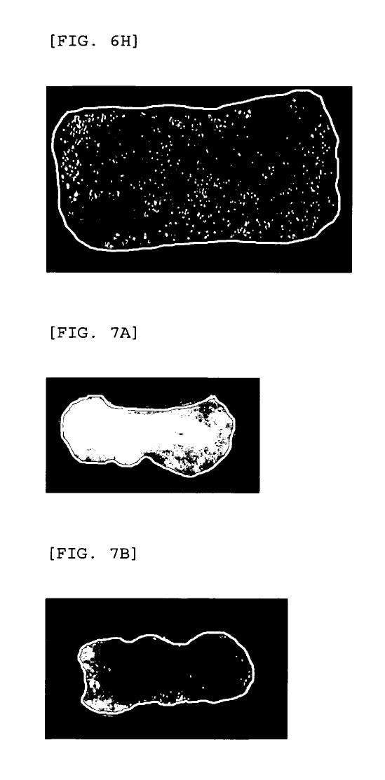

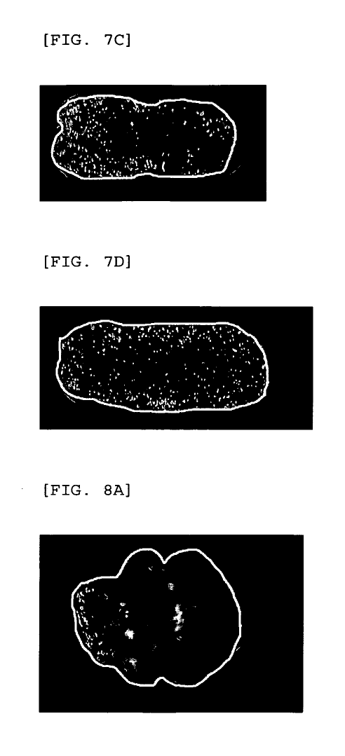

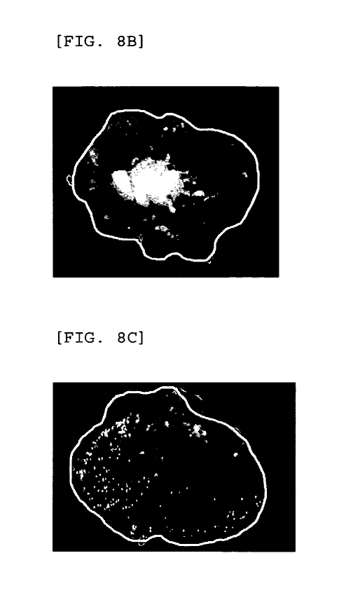

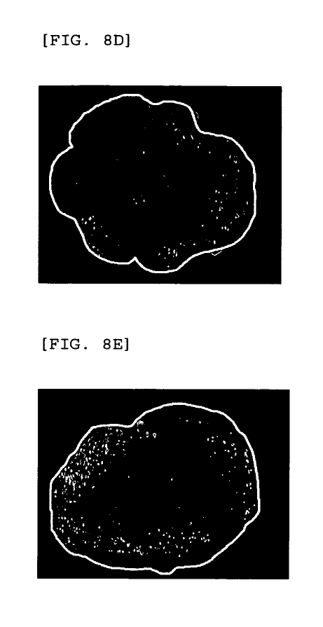

### DESCRIPTION OF THE SYMBOLS

A Prepared object forming step
B Shaping step
C Heating treatment step
D Standing step
E Water rinsing step
F Water draining step
P₁ First step (boiling treatment step)
P₂ Second step (aqueous solution contacting step)
P₃ Third step (wind drying step)

1. A method for manufacturing dried food to be eaten after cooking or reconstituting in hot water,
the dried food manufacturing method being characterized in successively subjecting a to-be-processed object, obtained by processing a prepared object of a raw material containing starchy matter to a predetermined shape, to at least the following steps (1) to (3):
(1) a first step of subjecting the to-be-processed object to a boiling treatment;
(2) a second step of putting the boiled to-be-processed object in contact with an aqueous solution after the first step; and
(3) a third step of subjecting the to-be-processed object, subjected to the second step, to a wind drying treatment at conditions of a temperature of 45 to 100° C. and a humidity of 5 to less than 55%.

2. The dried food manufacturing method according to claim 1, wherein the cross-sectional shape in the width direction of the to-be-processed object is rectangular or elliptical.

3. The dried food manufacturing method according to claim 1, wherein the third step is a step of blow drying by a non-circulating method and/or under a dehumidified environment.

4. The dried food manufacturing method according to claim 1, wherein a heating treatment is performed on the to-be-processed object before the first step.

5. The dried food manufacturing method according to claim 4, wherein the heating treatment is a steaming treatment.

6. The dried food manufacturing method according to claim 1, wherein the to-be-processed object is subject to standing between the second step and the third step.

7. The dried food manufacturing method according to claim 6, wherein the standing step is a step of leaving the to-be-processed object still in an indoor environment.

8. The dried food manufacturing method according to claim 7, wherein water rinsing of the to-be-processed object is performed after the standing.

9. The dried food manufacturing method according to claim 6, wherein the standing step is a step of immersing the to-be-processed object in an aqueous solution.

10. The dried food manufacturing method according to claims 1, wherein the starchy matter is a starchy matter derived from a raw material selected from the group consisting of wheat, buckwheat, rice, corn, mung bean, potato, sweat potato, and tapioca.

11. The dried food manufacturing method according to claim 1, wherein the dried food is a noodle.

12. The dried food manufacturing method according to claim 11, wherein the noodle is a non-fried instant noodle.

13. Dried noodle having the following textural structure or form characteristics (1) to (3):
(1) voids are present in the interior of noodle string after drying;
(2) cracks are present dispersedly in a range extending from a central portion to a surface of the noodle string after drying; and
(3) when a width direction cross-sectional shape of a noodle string is observed, a thinned portion is present.
